(19) United States
(12) Patent Application Publication
(10) Pub. No.: US 2025/0214808 A1
(43) Pub. Date: Jul. 3, 2025

(54) SYSTEM AND METHOD OF MONITORING AN ELEVATOR BELT FOR WEAR

(71) Applicant: OTIS ELEVATOR COMPANY, Farmington, CT (US)

(72) Inventors: Yingxin Gao, Farmington, CT (US); Kyle B. Martin, Avon, CT (US); Ian Hubbard, Berlin, CT (US)

(21) Appl. No.: 18/397,704

(22) Filed: Dec. 27, 2023

(51) Int. Cl. B66B 7/12; B66B 3/00; B66B 5/02; B66B 7/06

(52) U.S. Cl. CPC B66B 7/1215; B66B 3/002; B66B 5/02; B66B 7/062

(57) ABSTRACT

A system for monitoring wear of a tension member, having: a hoistway; a car; an elevator motor having a first sheave; a processor configured to: access historical data including at least one of prior usage data of the tension member and historical traffic pattern of the car; track real time data indicative of bends of segments of the tension member; determine from historical data and real time data a health condition of the segments of the tension member; issue a service alert when bends in one or more segments of the tension member exceeds a threshold; and control the car to transport an inspector to one or more locations along the hoistway that provide for visual inspection of at least one segment of the one or more segments that has a greater amount of bends relative to another segment of the one or more segments.

### BACKGROUND

The application is directed to elevator systems and more specifically to a system and method of monitoring an elevator belt for wear.

Elevator belt inspection is desirable to maintain proper operation of an elevator system. A resistance-based inspection (RBI) may not a feasible method to monitor a residual strength of an elevator belt. Physical devices to monitor the strength of the belt may also have limited use.

### BRIEF SUMMARY

Disclosed is a system for monitoring wear of a tension member, including: a hoistway configured to provide service to a plurality of floors; a car within the hoistway, the car being operationally coupled to the tension member; an elevator motor having a first sheave operationally coupled to the tension member to move the car; a processor, operationally coupled to a motor, wherein the processor is configured to: access historical data including at least one of prior usage data of the tension member and historical traffic pattern of the car; track real time data indicative of bends of segments of the tension member; determine from historical data and real time data a health condition of the segments of the tension member; issue a service alert when bends in one or more segments of the tension member exceeds a threshold; and control the car to transport an inspector to one or more locations along the hoistway that provide for visual inspection of at least one segment of the one or more segments that has a greater amount of bends relative to another segment of the one or more segments.

In addition to one or more aspects of the system or as an alternate, the processor is further configured to: track for each car run between floors: a car start floor; a motor start direction to identify a direction of movement in of the car within the hoistway; and a motor stop to identify a car end floor; render a first determination, from the tracking, of which one of the floors is associated with a greater amount of car travel relative to other ones of the floors; and render a second determination, from the historical data and the first determination, of which ones of the segments of the tension member is associated with the greater amount of bends relative to other ones of the segments.

In addition to one or more aspects of the system or as an alternate the car travel includes the car traveling to or from the one of the floors.

In addition to one or more aspects of the system or as an alternate the tension member has a first end and a second end that are opposite each other and connected to a top of the hoistway; the tension member carries the car between the first sheave and the first end of the tension member; and the tension member carries a counterweight via a second sheave located between the first sheave and the second end of the tension member.

In addition to one or more aspects of the system or as an alternate the processor identifies ones of the segments of the tension member that bend about the first sheave and the second sheave as the car travels between adjacent ones of the floors.

In addition to one or more aspects of the system or as an alternate the tension member is a coated steel belt having a core and a jacket.

In addition to one or more aspects of the system or as an alternate the processor is configured to track bends to the segments of the tension member from the first sheave and the second sheave to determine wear on the core of the tension member at each of the segments of the tension member, and to track bends to the segments of the tension member from the first sheave to determine wear on the jacket of the tension member at each of the segments of the tension member.

In addition to one or more aspects of the system or as an alternate the processor is configured to: generate a heatmap that identifies travels of the car between each of the floors, to thereby graphically identify relative wear on the segments of the tension member; and displaying on a display, by the processor, the heatmap.

Further disclosed is a method of monitoring wear of an tension member of an elevator system, including: accessing, by a processor from a non-transient memory, historical data including at least one of prior usage data of the tension member and historical traffic pattern of an elevator car that are indicative of bends of segments of the tension member, tracking real time data indicative of bends of the segments of the tension member; determining from the historical data and real time data a health condition of the segments of the tension member; issuing a service alert when bends in one or more segments of the tension member exceeds a threshold; and controlling a car within a hoistway to transport an inspector to one or more locations along the hoistway that provide for visual inspection of at least one segment of the one or more segments that has a greater amount of bends relative to another segment of the one or more segments.

In addition to one or more aspects of the method or as an alternate the method includes tracking, by the processor, for each run of the car between floors: a car start floor; a motor start direction to identify a direction of movement in of the car within the hoistway; a motor stop to identify a car end floor; rendering a first determination, by the processor from the tracking, of which ones of the floors is associated with a greater amount of car travel relative to other ones of the floors; and rendering a second determination, from the historical data and the first determination, of which ones of the segments of the tension member is associated with the greater amount of bends relative to other ones of the segments of the tension member.

In addition to one or more aspects of the method or as an alternate the car travel includes the car traveling to or from the one of the floors.

In addition to one or more aspects of the method or as an alternate an elevator motor having a first sheave is operationally coupled to the tension member to move the car; the tension member has a first end and a second end that are opposite each other and connected to a top of the hoistway; the tension member carries the car between the first sheave and the first end of the tension member; and the tension member carries a counterweight via a second sheave located between the first sheave and the second end of the tension member.

In addition to one or more aspects of the method or as an alternate the historical data includes a map that identifies ones of the segments of the tension member that bend about the first sheave and the second sheave as the car travels between adjacent ones of the floors.

In addition to one or more aspects of the method or as an alternate the tension member is a coated steel belt having a core and a jacket.

In addition to one or more aspects of the method or as an alternate the method includes tracking, by the processor, bends to the segments of the tension member from the first sheave and the second sheave to determine wear on the core of the tension member at each of the segments of the tension member.

In addition to one or more aspects of the method or as an alternate the method includes generating, by the processor, a heatmap that identifies travels of the car between each of the floors, to thereby graphically identify relative wear on the segments of the tension member; and displaying on a display, by the processor, the heatmap.

In addition to one or more aspects of the method or as an alternate the method includes controlling the car, by the processor, to transport an elevator inspector or field personnel to the one or more locations along the hoistway that provides for visual inspection of at least one of the segments of the tension member that has the greater amount of bends relative to other ones of the segments of the tension member.

Further disclosed is a system for monitoring wear of a tension member, including: a hoistway configured to provide service to a plurality of floors; a car within the hoistway, the car being operationally coupled to the tension member; an elevator motor having a first sheave operationally coupled to the tension member to move the car; and a processor, operationally coupled to a motor, wherein the processor is configured to: access historical data including at least one of prior usage data of the tension member and historical traffic pattern of the car to determine a health condition of the tension member.

In addition to one or more aspects of the system or as an alternate the historical data includes prior usage data that comprises a number of bends of the segments of the tension member.

In addition to one or more aspects of the system or as an alternate the processor is further configured to: render a determination, from the prior usage data, of the health condition of the tension member; and issue a service alert when the health condition is indicative of bends in one or more segments of the tension member exceeding a threshold.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2A shows the elevator car at a first floor and illustrates belt segments in a first location relative to the elevator car, the motor sheave and the counterweigh sheave;

FIG. 2B shows the elevator car at a second floor and illustrates belt segments in a second location relative to the elevator car, the motor sheave and the counterweigh sheave;

FIG. 2C shows an image of the belt along which segments are mapped based on a common segment size, and specific segments are labeled that are subject to bending as the elevator car moves between the first and second floors;

FIG. 3A graphically illustrates a mapping of motor starts and stops due to elevator car movement between floors;

FIG. 3B is a table of car travel permutations that result in travel between adjacent ones of the floors;

FIG. 4A shows a heatmap of accumulated car travels between adjacent floors;

FIG. 4B shows a person on the car that has traveled to inspect the belt segment that has experienced the most wear due to travels captured by the heatmap;

FIG. 4C shows the person on the car that has traveled to another location in the hoistway to inspect the belt segment, from a different viewpoint, that has experienced the most wear due to travels captured by the heatmap; and

FIG. 5 is a flowchart showing a method of monitoring an elevator belt for wear.

### DETAILED DESCRIPTION

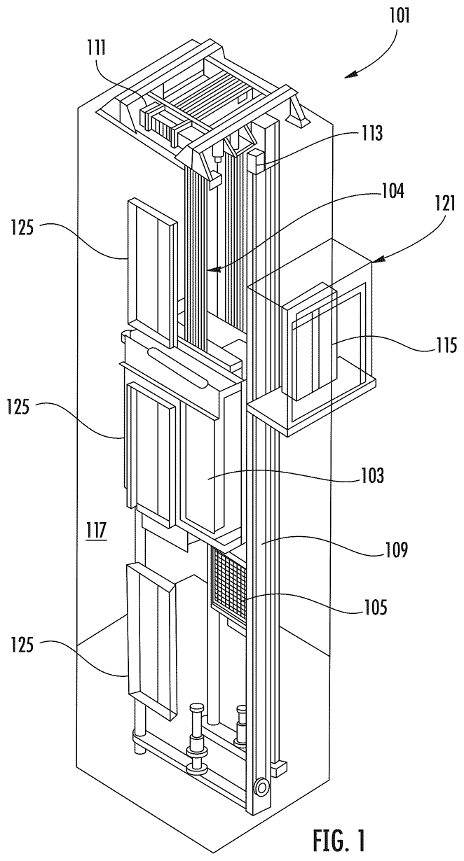

FIG. 1 is a perspective view of an elevator system 101 including an elevator car 103, a counterweight 105, a tension member 104, a guide rail (or rail system) 109, a machine (or machine system) 111, a position reference system 113, and an electronic elevator controller (controller) 115. The elevator car 103 and counterweight 105 are connected to each other by the tension member 104. The tension member 104 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft (or hoistway) 117 and along the guide rail 109.

The tension member 104 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The controller 115 may be in a controller room 121 of the elevator shaft 117. It is to be appreciated that the controller 115 need not be in the controller room 121 but may be in the hoistway or other location in the elevator system. According to an aspect, the controller 115 is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 104 to move the elevator car 103 within elevator shaft 117. The tension member 104 may include or be configured as, for example, ropes, steel cables, and/or coated-steel belts.

Although shown and described with a roping system including tension member 104, elevator systems that employ other methods and mechanisms of moving an elevator car within an elevator shaft may employ embodiments of the present disclosure. For example, embodiments may be employed in system that utilize a travel cable and in ropeless elevator systems using a linear motor to impart motion to an elevator car. Embodiments may also be employed in ropeless elevator systems using a hydraulic lift to impart motion to an elevator car. Embodiments may also be employed in ropeless elevator systems using self-propelled elevator cars (e.g., elevator cars equipped with friction wheels, pinch wheels, or traction wheels). FIG. 1 is merely a non-limiting example presented for illustrative and explanatory purposes.

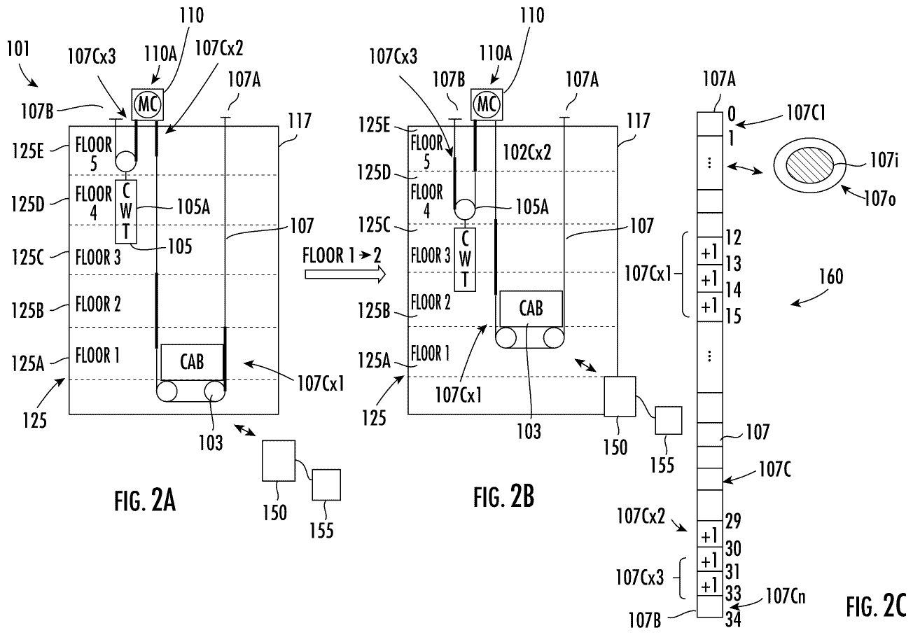

Turning to FIGS. 2A-2B, the system 101 includes the hoistway 117 and the car (or elevator car) 103 within the hoistway 117. The car 103 is configured to stop at any one of a plurality of floors (such as five floors 125A-125E (otherwise referred to as floors 1-5)) in the hoistway 117. To be sure, the number of floors could be more than five. The machine 110 drives a tension member 104. Such tension member may include a coated steel belt 107 having an inner steel core 107i and an outer jacket 107o (FIG. 2C) or sheathing. Herein, reference to a belt 107 is no intended on limiting the scope of the embodiments, which are equally applicable to other forms of tension members 104. The belt 107 extends from a first end 107A to a second end 107B that are connected to a top of the hoistway 117. The belt 107 supports the car 103 between the machine 110 and the first end 107A of the belt 107. The belt 107 supports a counterweight 105 between the machine 110 and the second end 107B. In operation, the belt 107 rolls over a first sheave 110A coupled to the machine 110 and over a sheave 105A coupled to the counterweight 105 when engaging the machine 110 and the counterweight 105.

The system 101 includes a processor 150, which may be the controller 115, operationally coupled to the motor 110. The processor 150 may have a non-transient memory 155 that stores historical data 158 in the form of an equation or formula and including at least one of prior usage data of the tension member and historical traffic pattern of the car 103. Processor 150 will also include real time data once captured to identify which segment has the most wear. In one embodiment, the processor 150 may store a map 160 of the elevator belt 107 (FIG. 2C) as the historical data 158. The historical data 158 may identify, relative to elevator motion, belt segments (or belt sections) 107C undergoing bends, and wear, while the elevator car 103 moves in the hoistway, including first through nth segments 107C1 . . . 107Cn (where n is 34 in the disclosed embodiments). Each of the belt segments 107C has a same unit length, such that where n is thirty-four (34) the belt 107 has thirty-four (34) segments 107C of the same length, for example one meter.

As the belt ends 107A, 107B and machine 110 are fixed, and gravity controls the location of the counterweight 105, the same segments 107C will bend each time the car 103 travels between adjacent floors. With reference to FIGS. 2A and 2C, which provide exemplary embodiments of the disclosure when the car 103 is configured to stop at five floors 125A-125E, segments (or segment cluster) 107Cx1, representing the 13^{th} to 15^{th} meters of the belt 107 are on one side of the car 103 when the car 103 is at the first floor 125A. Segment 107Cx2, representing the 30^{th} meter of the belt 107 is on one side of the first sheave 110A. Segments 107Cx3, corresponding to the 31^{st} and 32^{nd} meters of the belt 107, are on another side of the first sheave 110A, between the first and second sheaves 110A, 105A. With reference to FIG. 2C, segments 107Cx1 are on another side of the car 103 when the car 103 is at the second floor 125B. Segment 107Cx2 is on another side of the first sheave 110A. Segments 107Cx3 are on another side of the second sheave 105A, between the second 105A and the second end 107B of the belt 107. That is, as the car 103 moved between the first and second floors 125A, 125B, belt segments 107Cx1, 107Cx2 and 107Cx3 each underwent bending.

According to the embodiments, the historical data is configured to correlate the segments 107C with the bending based on movement of the car 103 between adjacent ones (or adjacent pairs) of the floors 125. For example, when the car 103 moves between the first and second floors 125B, 125C, the processor 150, accessing the historical data, would be configured to determine that segments 107Cx1, 107Cx2 and 107Cx3 each underwent bending. As indicated below, this enables the processor 150 to track repeated bending and thus wear of the belt 107.

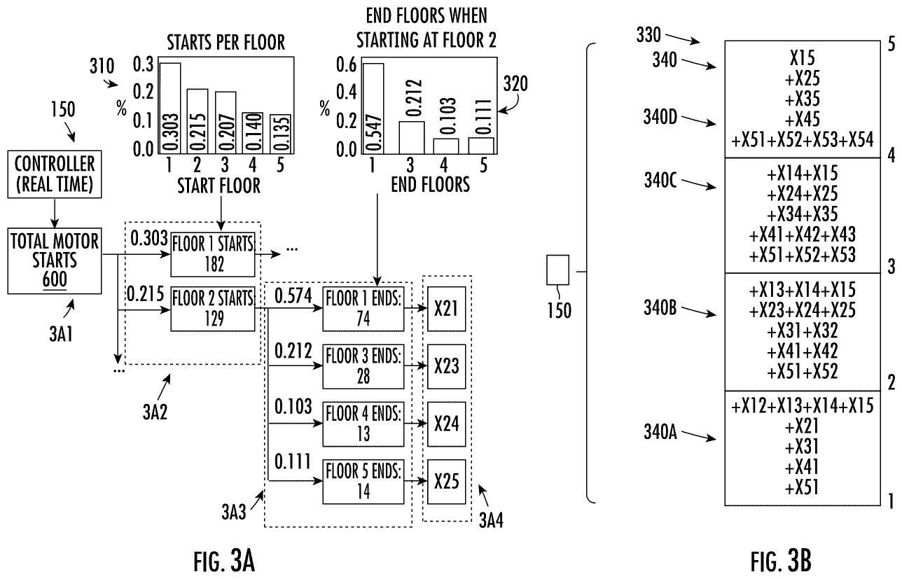

Turning to FIGS. 3A-3B, additional aspects are disclosed related to the processor 150 tracking wear of the belt 107. The processor accesses, from the non-transient memory 155, historical data 158 and, as shown in FIG. 3A, tracks real time use of the elevator belt 107. Specifically, the processor 150 tracks, for each car run between the floors 125, a car start floor 125, a motor start direction to identify a direction of movement in of the car 103 within the hoistway 117, and a motor stop to identify a car end floor 125.

The processor 150 is configured to render a first determination, from the tracking, of which one of the floors 125 is associated with a greater percentage (or amount) of car travel, e.g., to or from the one of the floors 125, relative to the other floors 125. The processor 150 is configured to render a second determination, from the accessing of the historical data 158 and the first determination, of which ones of the belt segments 107C is associated with a greater percentage of bends relative to other ones of the belt segments 107C. The processor 150 is further configured to issue a service alert when bends in the one or more of the belt segments 107C exceeds a threshold, indicative of wear that may require maintenance.

For example, as shown in FIG. 3A, the motor 110 may have 600 starts as shown in box 3A1. As shown in box 3A2, 182 of the starts may be from floor 1, e.g., where the car 103 is traveling from the first floor 125A to another floor 125. Further, 129 of the starts may be from floor 2, e.g., where the car 103 is traveling from the second floor 125B to another floor 125. As indicated and shown statistically in graph 310, 0.303, or 30.3% of the 600 motor starts are from floor 1. Further, 0.215 or 21.5% of the motor starts are from floor 2. Further, 0.207 or 20.7% of the motor starts are from floor 3. Further, 0.140 or 14.7% of the motor starts are from floor 4. Further, 0.135 or 13.5% of the motor starts are from floor 5.

With continued reference to FIG. 3A, as shown in box 3A3, and focusing on the motor starts from floor 2, e.g., from the second floor 125B, 74 ends (or locations where the elevator stopped for any period for any reason, including but not limited to dropping off or picking up passengers) were at floor 1. Further, 28 ends were at floor 3. Further, 13 ends were at floor 4. Further, 14 ends were at floor 5. As shown statistically in graph 320, 0.574 or 57.4% of the ends were at floor 1. Further, 0.212 or 21.2% of the ends were at floor 3. Further, 0.103 or 10.3% of the ends were at floor 4. Further, 0.111 or 11.1% of the ends were at floor 5. As shown in box 3A4, these trips were designated X21, X23, X24 and X25, where X represents the trip, the first digit (2) adjacent to the X represents the start floor and the second digit (1, 3, 4 or 5) represents the end floor.

FIG. 3B shows a table 330 with four cells 340A-340B (generally 340), each of which is a summation of trips between adjacent ones of the floors 125 based on travel combinations that could occur between all the floors 125. It is to be appreciated that there are four cells 340 because there are five floors 125. That is, the car 103 travels between consecutively adjacent floors in a five floor hoistway will have only four options, i.e., between floors 1 and 2 (cell 340A), between floors 2 and 3 (cell 340B), between floors 3 and 4 (cell 340C), and between floors 4 and 5 (cell 340D).

As shown in the first cell 340A, the elevator car 103 may travel between the first and second floors 125A, 125B when traveling between floors 1 and 2 (X12), between floors 1 and 3 (X13), between floors 1 and 4 (X14), and between floors 1 and 5 (X15). For each of these runs the elevator car 103 may travel between the first and second floors 125A, 125B in the reverse direction (e.g., X21, X31, X41, X51). Thus, the first cell 340A lists eight travel options, or permutations, in the hoistway that result in traveling between floors 1 and 2.

As shown in the second cell 340B, the elevator car 103 may travel between the second and third floors 125B, 125C when traveling between floors 1 and 3 (X13), between floors 1 and 4 (X14), between floors 1 and 5 (X15), between floors 2 and 3 (X23), between floors 2 and 4 (X24) and between floors 2 and 5 (X25). For each of these runs, the elevator car 103 may travel between the second and third floors 125B, 125C in the reverse direction (e.g., X31, X41, X51, X32, X42, X52). Thus, the second cell 340B lists twelve travel options, or permutations, in the hoistway that result in traveling between floors 2 and 3.

As shown in the third cell 340C, the elevator car 103 may travel between the third and fourth floors 125C, 125D when traveling between floors 1 and 4 (X14), between floors 1 and 5 (X15), between floors 2 and 4 (X24), between floors 2 and 5 (X25), between floors 3 and 4 (X34) and between floors 3 and 5 (X35). For each of these runs the elevator car 103 may travel between the third and fourth floors 125C, 125D in the reverse direction (e.g., X41, X51, X42, X52, X43, X53). Thus, the third cell 340C lists twelve travel options, or permutations, in the hoistway that result in traveling between floors 3 and 4.

As shown in the fourth cell 340D, the elevator car 103 may travel between the fourth and fifth floors 125C, 125D when traveling between floors 1 and 5 (X15), between floors 2 and 5 (X25), between floors 3 and 5 (X35), and between floors 4 and 5 (X45). For each of these runs the elevator car 103 may travel between the fourth and fifth floors 125C, 125D in the reverse direction (e.g., X51, X52, X53, X54). Thus, the fourth cell 340D lists eight travel options, or permutations, in the hoistway that result in traveling between floors 4 and 5.

In one embodiment, the processor 150 is configured to track bends to the belt segments 107C from both the first sheave 110A and from the second sheave 105A to determine wear on the core 107i and jacket 107o of the belt 107 at each of the belt segments 107C. In one embodiment, the processor 150 is configured to track bends to the belt segments 107C from only the first sheave 110A to determine wear on the jacket 107o of the belt 107 at each of the belt segments 107C.

The above embodiments utilize cycle counts to map out the bends along the belt for health monitoring of a coated steel belt (CSB). According to the embodiments, every trip counts has one motor start. The embodiments involve utilizing historical traffic patterns and the real time motor starts to calculate total bends at each belt segment, where each segment is a same length. The historical traffic pattern (motor starts per floor and motor ends or stops per floor) based on speed, rise and building type are summarized by statistically using the historical traffic data, which is tested and updated periodically. Combined with the motor starts that are collected real time, the number of times that the elevator passes between an ith and the next floor j=i+1 (X(i,j), where i=1, 2, . . . , n−1, and j=i+1, and n is number of total floors) is calculated as the summation of all the up and down trips (or runs) passing between each specific two consecutive floors (X(i,j)) as showing in FIGS. 2A-2C, 3A and 3B. The value of X(i,j) is used as the health metric with a corresponding retirement criterion. The embodiments provide a method of monitoring the CSB health in real time. The embodiments allows a mapping of fatigue of the CSB utilizing an approach that can be applied to various elevator components for health monitoring, including rope, travelling cable, machine, etc.

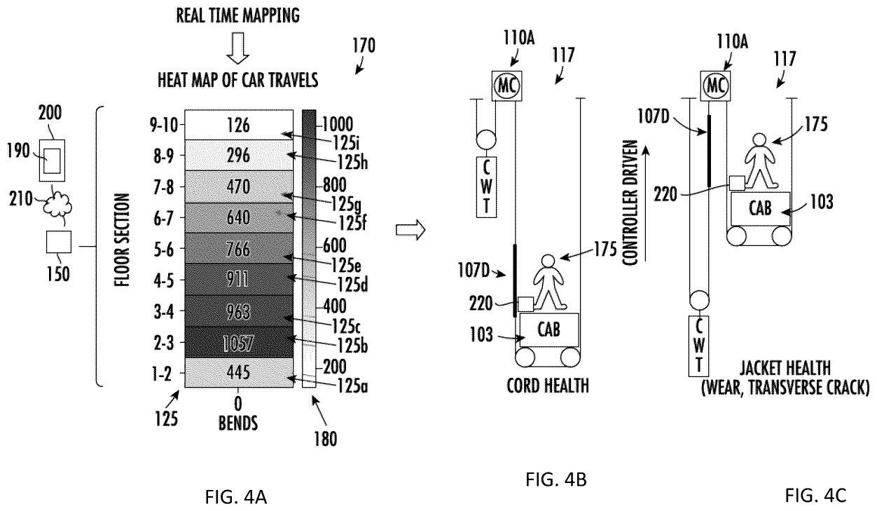

Turning to FIG. 4A, the processor 150 is configured to generate a heatmap 170 that illustrates car travels between floors 125 based on the accounting technique discussed above. A legend 180 for the heatmap 170 may also be provided. The processor 150 may display the heatmap on a display 190 of a device 200, such as a smartphone that communicates with the processor 150 over a wireless network 210. As shown in FIG. 4A, the hoistway 117 may service 10 floors so that the heatmap has 9 stacked layers 125A-125i for reasons indicated above. As indicated the processor 150 counted 445 travels between floors 1 and 2. Further, the processor counted 1057 travels between floors 2 and 3. Further, the processor counted 963 travels between floors 3 and 4. Further, the processor counted 911 travels between floors 4 and 5. Further, the processor counted 766 travels between floors 5 and 6. Further, the processor counted 640 travels between floors 6 and 7. Further, the processor counted 470 travels between floors 7 and 8. Further, the processor counted 396 travels between floors 8 and 9. Further, the processor counted 126 travels between floors 9 and 10. As indicated by the legend and the statistics, the travels between the second and third floors, based on the car traveling throughout the hoistway between various combination of floors, was greater than between the other floors.

As can be appreciated, to accommodate the 10-floor configuration implicated in FIG. 4A, the belt map 160 (FIG. 3B) would be sized to fit the hoistway, and to identify segments that bend from travels between each of the floors, including the second and third floors, from interactions between sheaves. Thus, with the heatmap in FIG. 4A, and the belt map, there can be a determination that certain belt segments may need maintenance due to bend induced wear between, e.g., floors 2 and 3.

As shown in FIG. 4B, the processor 150 may control the car 103 when a person (i.e., an elevator inspector or field personnel) 175 is riding on the car 103 to take the elevator inspector 175 to one or more locations along the hoistway 117 that provide for visual inspection of at least one of the belt segments 107D that has the greater percentage of accumulated (or greater amount of) bends relative to other ones of the belt segments. These segments 107D may correspond to the segments that are bent when the car 103 moves between the second and third floors 125. To inspect all sides of the belt segments 107D, the car 103 may be moved upwardly and downwardly, to position the segments 107D on either side of the first sheave 110A, such as shown in FIG. 4C, providing a different view of the belt 107 than in FIG. 4B. Alternatively, a sensor 220 mounted to the car 103 may be connected to the processor 150 via wireless or wired connections. The processor may direct the car 103 to the belt segments 107D for transmission of sensor data that visually captures a condition of the segments 107D, which may be utilized to determine a wear condition of the belt 107.

Accordingly, the embodiments provide for using cycle counts as retirement criteria for a high strength coated steel belt (CSB). The embodiments utilize either real time or historical data of travelling floors for each trip (run), with which the usage of each belt segments can be derived. With such information, a focused inspection of suspension, including CSB and ropes, becomes possible. Specifically, the embodiments provide a method to utilize the elevator controller to take the mechanic to the floors that can view the CSB segments that experience most cord bending (from both machine and, e.g., idler, sheaves) and/or jacket wear (i.e., the segments that pass machine sheave the most), respectively. The embodiments provide for dividing the belt into segments of certain lengths. The embodiments further provide for utilizing real-time mapping of the car travels to generate the heatmap to identify the segments that have most bending and the jacket wear. The method further provides for the controller calculating and recording the corresponding car positions or floors in the hoistway that provide needed views for inspecting the corresponding belt segments based on the layout of the hoistway. The embodiments further provide for the controller taking an inspection mechanic to the corresponding floors for viewing the belt segments that have undergone excessive wear. The mechanics can request a controller guided inspection via a service tool.

Benefits of the embodiments include allowing an elevator suspension inspection and enable an inspection with a focus on high usage segments. The embodiments also save inspection time relative to other forms of inspection. The approach identified by the embodiments can be applied to other elevator components for focused inspection, such as travelling cable.

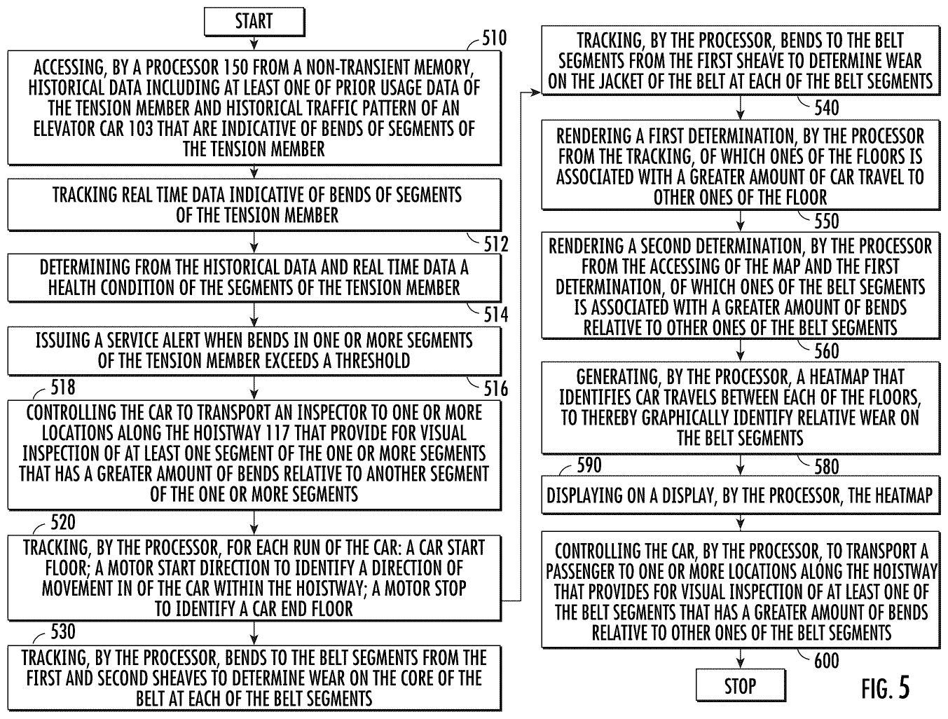

Turning now to FIG. 5 a flowchart shows a method of tracking an elevator belt for wear. As shown in block 510, the method includes accessing, by a processor 150 from a non-transient memory 155, historical data 158 including at least one of prior usage data of the tension member 104 and historical traffic pattern of an elevator car 103 that are indicative of bends of segments of the tension member 140. As shown in block 512 the method includes tracking real time data indicative of bends of segments of the tension member 104. As shown in block 514 the method includes determining from the historical data and real time data a health condition of the segments of the tension member 104. As shown in block 516 the method includes issuing a service alert when bends in one or more segments of the tension member exceeds a threshold. As shown in block 518 the method includes controlling the car to transport an inspector to one or more locations along the hoistway 117 that provide for visual inspection of at least one segment of the one or more segments that has a greater amount of bends relative to another segment of the one or more segments.

As shown in block 520, the method includes tracking, by the processor 150, for each run of the car: a car start floor 125; a motor start direction to identify a direction of movement in of the car 103 within the hoistway 117; a motor stop to identify a car end floor 125. As shown in block 530, the method includes tracking, by the processor 150, bends to the belt segments from the first and second sheaves 110A, 105A to determine wear on the core 107i of the belt 107 at each of the belt segments 107C.

As shown in block 540, the method includes tracking, by the processor 150, bends to the belt segments 107C from the first sheave 110A to determine wear on the jacket 107o of the belt 107 at each of the belt segments 107C. As shown in block 550, the method includes rendering a first determination, by the processor 150 from the tracking, of which ones of the floors 125 is associated with a greater amount of car travel relative to the other floors 125.

As shown in block 560, the method includes rendering a second determination, by the processor 150 from the accessing of the historical data and the first determination, of which ones of the belt segments 107C is associated with a greater amount of bends relative to other ones of the belt segments 107C.

As shown in block 580, the method includes generating, by the processor 150, a heatmap 170 that identifies car travels between each of the floors 125, to thereby graphically identify relative wear on the belt segments 107C. As shown in block 590, the method includes displaying on a display 190, by the processor 150, the heatmap 170. As shown in block 600, the method includes controlling the car 103, by the processor, to transport an elevator inspector to one or more locations along the hoistway 117 that provides for visual inspection of at least one of the belt segments 107C that has a greater amount of bends relative to other ones of the belt segments 107C.

The above embodiments use historical data to aid in visual inspection or to retire belt. Real time and historical data is utilized to assess health of belt and aid mechanic in inspection efforts, which results in an increased efficiency. The system enables guiding mechanics to high-risk areas of potential failure. While the embodiments refer to tension members, as indicated, the tension member may include or be configured as, for example, ropes, steel cables, and/or coated-steel belts.

Sensor data identified herein may be obtained and processed separately, or simultaneously and stitched together, or a combination thereof, and may be processed in a raw or complied form. The sensor data may be processed on the sensor (e.g., via edge computing), by controllers identified or implicated herein, on a cloud service, or by a combination of one or more of these computing systems. The senor may communicate the data via wired or wireless transmission lines, applying one or more protocols as indicated below.

Wireless connections may apply protocols that include local area network (LAN, or WLAN for wireless LAN) protocols. LAN protocols include WiFi technology, based on the Section 802.11 standards from the Institute of Electrical and Electronics Engineers (IEEE). Other applicable protocols include Low Power WAN (LPWAN), which is a wireless wide area network (WAN) designed to allow long-range communications at a low bit rate, to enable end devices to operate for extended periods of time (years) using battery power. Long Range WAN (LoRaWAN) is one type of LPWAN maintained by the LoRa Alliance and is a media access control (MAC) layer protocol for transferring management and application messages between a network server and application server, respectively. LAN and WAN protocols may be generally considered TCP/IP protocols (transmission control protocol/Internet protocol), used to govern the connection of computer systems to the Internet. Wireless connections may also apply protocols that include private area network (PAN) protocols. PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same.

Wireless connections may also include radio-frequency identification (RFID) technology, used for communicating with an integrated chip (IC), e.g., on an RFID smartcard. In addition, Sub-1 Ghz RF equipment operates in the ISM (industrial, scientific, and medical) spectrum bands below Sub 1 Ghz—typically in the 769-935 MHz, 315 Mhz and the 468 Mhz frequency range. This spectrum band below 1 Ghz is particularly useful for RF IOT (internet of things) applications. The Internet of things (IOT) describes the network of physical objects—“things”—that are embedded with sensors, software, and other technologies for the purpose of connecting and exchanging data with other devices and systems over the Internet. Other LPWAN-IOT technologies include narrowband internet of things (NB-IOT) and Category M1 internet of things (Cat M1-IOT). Wireless communications for the disclosed systems may include cellular, e.g., 2G/3G/4G (etc.). Other wireless platforms based on RFID technologies include Near-Field-Communication (NFC), which is a set of communication protocols for low-speed communications, e.g., to exchange date between electronic devices over a short distance. NFC standards are defined by the ISO/IEC (defined below), the NFC Forum and the GSMA (Global System for Mobile Communications) group. The above is not intended on limiting the scope of applicable wireless technologies.

Wired connections may include connections (cables/interfaces) under RS (recommended standard)-422, also known as the TIA/EIA-422, which is a technical standard supported by the Telecommunications Industry Association (TIA) and which originated by the Electronic Industries Alliance (EIA) that specifies electrical characteristics of a digital signaling circuit. Wired connections may also include (cables/interfaces) under the RS-232 standard for serial communication transmission of data, which formally defines signals connecting between a DTE (data terminal equipment) such as a computer terminal, and a DCE (data circuit-terminating equipment or data communication equipment), such as a modem. Wired connections may also include connections (cables/interfaces) under the Modbus serial communications protocol, managed by the Modbus Organization. Modbus is a master/slave protocol designed for use with its programmable logic controllers (PLCs) and which is a commonly available means of connecting industrial electronic devices. Wireless connections may also include connectors (cables/interfaces) under the PROFibus (Process Field Bus) standard managed by PROFIBUS & PROFINET International (PI). PROFibus which is a standard for fieldbus communication in automation technology, openly published as part of IEC (International Electrotechnical Commission) 61158. Wired communications may also be over a Controller Area Network (CAN) bus. A CAN is a vehicle bus standard that allow microcontrollers and devices to communicate with each other in applications without a host computer. CAN is a message-based protocol released by the International Organization for Standards (ISO). The above is not intended on limiting the scope of applicable wired technologies.

When data is transmitted over a network between end processors as identified herein, the data may be transmitted in raw form or may be processed in whole or part at any one of the end processors or an intermediate processor, e.g., at a cloud service (e.g., where at least a portion of the transmission path is wireless) or other processor. The data may be parsed at any one of the processors, partially or completely processed or complied, and may then be stitched together or maintained as separate packets of information. Each processor or controller identified herein may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory identified herein may be but is not limited to a random-access memory (RAM), read only memory (ROM), or other electronic, optical, magnetic or any other computer readable medium.

The controller may further include, in addition to a processor and non-volatile memory, one or more input and/or output (I/O) device interface(s) that are communicatively coupled via an onboard (local) interface to communicate among other devices. The onboard interface may include, for example but not limited to, an onboard system bus, including a control bus (for inter-device communications), an address bus (for physical addressing) and a data bus (for transferring data). That is, the system bus may enable the electronic communications between the processor, memory, and I/O connections. The I/O connections may also include wired connections and/or wireless connections identified herein. The onboard interface may have additional elements, which are omitted for simplicity, such as controllers, buffers (caches), drivers, repeaters, and receivers to enable electronic communications. The memory may execute programs, access data, or lookup charts, or a combination of each, in furtherance of its processing, all of which may be stored in advance or received during execution of its processes by other computing devices, e.g., via a cloud service or other network connection identified herein with other processors.

Embodiments can be in the form of processor-implemented processes and devices for practicing those processes, such as processor. Embodiments can also be in the form of computer code based modules, e.g., computer program code (e.g., computer program product) containing instructions embodied in tangible media (e.g., non-transitory computer readable medium), such as floppy diskettes, CD ROMs, hard drives, on processor registers as firmware, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or carling, through fiber optics, or via electromagnetic radiation, wherein, when the computer program code is loaded into and executed by a computer, the computer becomes a device for practicing the exemplary embodiments. When implemented on a general-purpose microprocessor, the computer program code segments configure the microprocessor to create specific logic circuits.

The terminology used herein is for the purpose of describing embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description but is only limited by the scope of the appended claims.

What is claimed is:

1. A system for monitoring wear of a tension member, comprising:
a hoistway configured to provide service to a plurality of floors;
a car within the hoistway, the car being operationally coupled to the tension member;
an elevator motor having a first sheave operationally coupled to the tension member to move the car;
a processor, operationally coupled to a motor, wherein the processor is configured to:
access historical data including at least one of prior usage data of the tension member and historical traffic pattern of the car;
track real time data indicative of bends of segments of the tension member;
determine from historical data and real time data a health condition of the segments of the tension member;
issue a service alert when bends in one or more segments of the tension member exceeds a threshold; and
control the car to transport an inspector to one or more locations along the hoistway that provide for visual inspection of at least one segment of the one or more segments that has a greater amount of bends relative to another segment of the one or more segments.

2. The system of claim 1, wherein the processor is further configured to:
track for each car run between floors:
a car start floor;
a motor start direction to identify a direction of movement in of the car within the hoistway; and
a motor stop to identify a car end floor;
render a first determination, from the tracking, of which one of the floors is associated with a greater amount of car travel relative to other ones of the floors; and
render a second determination, from the historical data and the first determination, of which ones of the segments of the tension member is associated with the greater amount of bends relative to other ones of the segments.

3. The system of claim 2, wherein the car travel includes the car traveling to or from the one of the floors.

4. The system of claim 3, wherein:
the tension member has a first end and a second end that are opposite each other and connected to a top of the hoistway;
the tension member carries the car between the first sheave and the first end of the tension member; and
the tension member carries a counterweight via a second sheave located between the first sheave and the second end of the tension member.

5. The system of claim 4, wherein the processor identifies ones of the segments of the tension member that bend about the first sheave and the second sheave as the car travels between adjacent ones of the floors.

6. The system of claim 5, wherein the tension member is a coated steel belt having a core and a jacket.

7. The system of claim 6, wherein the processor is configured to track bends to the segments of the tension member from the first sheave and the second sheave to determine wear on the core of the tension member at each of the segments of the tension member, and to track bends to the segments of the tension member from the first sheave to determine wear on the jacket of the tension member at each of the segments of the tension member.

8. The system of claim 2, wherein the processor is configured to:
generate a heatmap that identifies travels of the car between each of the floors, to thereby graphically identify relative wear on the segments of the tension member; and
displaying on a display, by the processor, the heatmap.

9. A method of monitoring wear of an tension member of an elevator system, comprising:
accessing, by a processor from a non-transient memory, historical data including at least one of prior usage data of the tension member and historical traffic pattern of an elevator car that are indicative of bends of segments of the tension member,
tracking real time data indicative of bends of the segments of the tension member;
determining from the historical data and real time data a health condition of the segments of the tension member;
issuing a service alert when bends in one or more segments of the tension member exceeds a threshold; and
controlling a car within a hoistway to transport an inspector to one or more locations along the hoistway that provide for visual inspection of at least one segment of the one or more segments that has a greater amount of bends relative to another segment of the one or more segments.

10. The method of claim 9, further comprising:
tracking, by the processor, for each run of the car between floors:
a car start floor;
a motor start direction to identify a direction of movement in of the car within the hoistway;
a motor stop to identify a car end floor;
rendering a first determination, by the processor from the tracking, of which ones of the floors is associated with a greater amount of car travel relative to other ones of the floors; and
rendering a second determination, from the historical data and the first determination, of which ones of the segments of the tension member is associated with the greater amount of bends relative to other ones of the segments of the tension member.

11. The method of claim 10, wherein the car travel includes the car traveling to or from the one of the floors.

12. The method of claim 10, wherein:
an elevator motor having a first sheave is operationally coupled to the tension member to move the car;
the tension member has a first end and a second end that are opposite each other and connected to a top of the hoistway;
the tension member carries the car between the first sheave and the first end of the tension member; and
the tension member carries a counterweight via a second sheave located between the first sheave and the second end of the tension member.

13. The method of claim 12, wherein the historical data includes a map that identifies ones of the segments of the tension member that bend about the first sheave and the second sheave as the car travels between adjacent ones of the floors.

14. The method of claim 13, wherein the tension member is a coated steel belt having a core and a jacket.

15. The method of claim 14, comprising tracking, by the processor, bends to the segments of the tension member from the first sheave and the second sheave to determine wear on the core of the tension member at each of the segments of the tension member.

16. The method of claim 10, including:
generating, by the processor, a heatmap that identifies travels of the car between each of the floors, to thereby graphically identify relative wear on the segments of the tension member; and
displaying on a display, by the processor, the heatmap.

17. The method of claim 16, including:
controlling the car, by the processor, to transport an elevator inspector or field personnel to the one or more locations along the hoistway that provides for visual inspection of at least one of the segments of the tension member that has the greater amount of bends relative to other ones of the segments of the tension member.

18. A system for monitoring wear of a tension member, comprising:
a hoistway configured to provide service to a plurality of floors;
a car within the hoistway, the car being operationally coupled to the tension member;
an elevator motor having a first sheave operationally coupled to the tension member to move the car; and
a processor, operationally coupled to a motor, wherein the processor is configured to:
access historical data including at least one of prior usage data of the tension member and historical traffic pattern of the car to determine a health condition of the tension member.

19. The system of claim 18, wherein the historical data includes prior usage data that comprises a number of bends of the segments of the tension member.

20. The system of claim 19, wherein the processor is further configured to:
render a determination, from the prior usage data, of the health condition of the tension member; and
issue a service alert when the health condition is indicative of bends in one or more segments of the tension member exceeding a threshold.
